(19) United States
(12) Patent Application Publication
(10) Pub. No.: US 2013/0339046 A1
(43) Pub. Date: Dec. 19, 2013

(54) MEDICAL APPARATUS, INFORMATION SYSTEM AND DATA RECOVERY METHOD

(71) Applicants: Toshiba Medical Systems Corporation, Otawara-shi (JP); Kabushiki Kaisha Toshiba, Minato-ku (JP)

(72) Inventors: Sho TANAKA, Nasushiobara-shi (JP); Megumu Fukuda, Nasushiobara-shi (JP)

(21) Appl. No.: 13/921,548

(22) Filed: Jun. 19, 2013

(30) Foreign Application Priority Data
Jun. 19, 2012 (JP) 2012-137557

(51) Int. Cl. G06F 19/00

(52) U.S. Cl. CPC G06F 19/32
USPC 705/2

(57) ABSTRACT

A medical apparatus according to an embodiment includes a storage unit configured to store medical information, a communication controller configured to communicate, via a communication network, the medical information with other equipment connected to the communication network, a controller configured to manage transmission of the medical information to the other equipment and a task performed by the medical apparatus, and a task consignment preparation unit configured to prepare a storage medium storing information necessary for the medical apparatus to consign a task performed by the medical apparatus to another apparatus connected to the communication network.

### CROSS-REFERENCE TO THE RELATED APPLICATION

This application is based on and claims the benefit of priority from Japanese Patent Application No. 2012-137557, filed on Jun. 19, 2012; the entire contents of which are incorporated herein by reference.

### FIELD

Embodiments described herein relate generally to a medical apparatus, an information system, and a data recovery method.

### BACKGROUND

In recent years, various networks to which information terminals such as computers, servers, and other equipment are connected have been constructed everywhere in society. This also applies to the field of medicine, and systems have been constructed in which medical apparatuses are connected to, for example, an image server, modality and the like via a communication network.

However, use of the communication network is under constant risk of disconnection due to line failure, occurrence of a virus-related problem, and the like. When the communication network is disconnected owing to some failure, the system using the communication network is also affected heavily. Hence, the communication network is constructed to be capable of avoiding occurrence of network failure, or restoring the failed network speedily when failure occurs.

The invention described in Japanese Patent Application Publication No. 2010-182154 prepares a backup apparatus used in case of occurrence of failure of a communication network, and if failure occurs, uses the backup apparatus to continue a task.

However, the invention disclosed in the above document does not consider the following points.

Specifically, the above-described invention is intended to prevent interruptions of a task by using the backup apparatus. However, after restoration of the communication network, it is difficult to incorporate contents of a task performed by the backup apparatus in the task performed by an apparatus which was unavailable due to failure of the communication network. Further, it is also difficult for the apparatus which was unavailable to refer to the contents of the task or data in the backup apparatus after the restoration.

Furthermore, the backup apparatus has to be prepared in anticipation of occurrence of failure of the communication network. This preparation means, on the other hand, to fixedly use the backup apparatus when failure occurs. When the backup apparatus is predetermined in this way, the takeover of tasks cannot be done to begin with if the backup apparatus itself is affected by failure of the communication network.

### BRIEF DESCRIPTION OF THE DRAWINGS

FIG. 1 is a block diagram showing the overall configuration of an information system including a medical apparatus in an embodiment.

FIG. 2 is a block diagram showing the internal configuration of the medical apparatus in the embodiment.

FIG. 3 is a block diagram showing the internal configuration of another apparatus in the embodiment.

FIG. 4 is a block diagram showing the configuration of a consigned task unit in the embodiment.

FIG. 5 is a sequence diagram showing a flow of task consignment in a first embodiment.

FIG. 6 is a sequence diagram showing a flow of task consignment in the first embodiment.

FIG. 7 is a sequence diagram showing a flow of task consignment in a second embodiment.

### DETAILED DESCRIPTION

According to one embodiment, a medical apparatus comprises: a storage unit configured to store medical information; a communication controller configured to communicate, via a communication network, the medical information with other equipment connected to the communication network; a controller configured to manage transmission of the medical information to the other equipment and a task performed by the medical apparatus; and a task consignment preparation unit configured to prepare a storage medium storing information necessary for the medical apparatus to consign a task performed by the medical apparatus to another apparatus connected to the communication network.

Further, according to another embodiment, an information system comprises; a medical apparatus including a storage unit configured to store medical information, a communication controller configured to communicate, via a communication network, the medical information with other equipment connected to the communication network, a controller configured to manage transmission of the medical information to the other equipment and a task performed by the medical apparatus, and a task consignment preparation unit configured to prepare a storage medium storing information necessary for the medical apparatus to consign a task performed by the medical apparatus to another apparatus connected to the communication network; a server which is a counterpart of the medical apparatus for the task; and another apparatus which is any apparatus connected to the communication network and which accepts consignment of the task from the medical apparatus and continues the task with the server.

Further, according to yet another embodiment, a data recovery method comprises the steps of; storing, in a storage medium, information necessary in consigning a task performed by a medical apparatus to any apparatus connected to a communication network; passing the storage medium to the other apparatus and causing the other apparatus to take over the task consigned thereto; storing, by the other apparatus, a result of the task in the storage medium; passing the storage medium storing the result of the task to the medical apparatus and thereby acquiring, by the medical apparatus, the result of the task; and incorporating the result of the task in a result of the task in the medical apparatus.

Further, according to still another embodiment, a data recovery method comprises the steps of: storing, in a storage medium, information necessary in consigning a task performed by a medical apparatus to any apparatus connected to a communication network; passing the storage medium to other apparatus and causing the other apparatus to take over the task consigned thereto; storing, by the other apparatus, a result of the task in the storage medium; sending the result of the task from the other apparatus to the medical apparatus via the communication network; receiving and acquiring, by the medical apparatus, the result of the task; and incorporating the result of the task in a result of the task in the medical apparatus.

Now, embodiments of the present invention will be described below in detail with reference to the accompanying drawings.

### First Embodiment

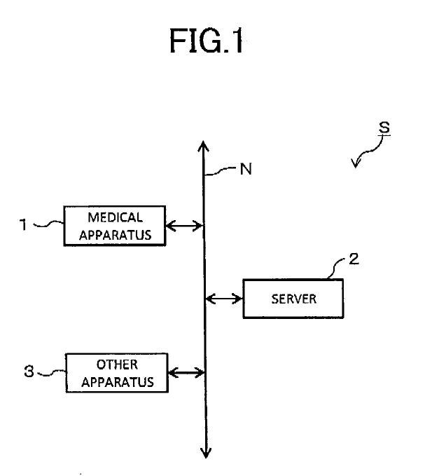

FIG. 1 is a block diagram showing the overall configuration of an information system S including a medical apparatus 1 in an embodiment. The information system S includes the medical apparatus 1, a server 2, another apparatus 3, and a communication network N that connects them together. The information system S may be configured as an independent system, or may constitute all or some of various management systems constructed within a medical institution, such as a hospital information system (HIS), a radiological information system (RIS), and a picture archiving communication system (PACS).

The medical apparatus 1 is, for example, a modality such as an ultrasonograph or an X-ray computed tomography (CT) apparatus, and includes functions for collecting information on the interior of a subject and producing medical images of the interior of the subject based on the information collected. Besides the above-described modalities, the medical apparatus 1 herein may be an information terminal such as, for example, a workstation.

The server 2 is connected to the communication network N. The server 2 performs a task with the medical apparatus 1 via the communication network N, and is thus a counterpart of the medical apparatus 1 performing the task. Examples of the server 2 include an image server configured to store therein information on the interior of a subject imaged by the medical apparatus 1. By being connected to the communication network N, the server 2 is connected not only to the medical apparatus 1 but also other apparatuses connected to the communication network N.

The other apparatus 3 is an apparatus excluding the medical apparatus 1 performing a task with the server 2 and that sever 2, which are connected to the communication network N. The role of the other apparatus 3 is to perform a task performed by the medical apparatus 1 instead of the medical apparatus 1 when the communication network N is disconnected, i.e., when communication failure occurs while the task is performed between the medical apparatus 1 and the server 2. Thus, the other apparatus 3 is a medical apparatus, an information terminal, or the like other than the medical apparatus 1 performing a task, and needs to have a capability (spec) of taking over the task performed by the medical apparatus 1 which is unavailable due to communication failure between the medical apparatus 1 and the server 2. The other apparatus 3 may be any apparatus as long as it possesses such a capability.

The communication network N connects the medical apparatus 1, the server 2, and the other apparatus 3 to one another, and allows exchange of, for example, contents of a task and medical information such as information on a medical image. Examples of the communication network N include networks such as a local area network (LAN) and the Internet. Communication standards employed in the communication network N may be any standards, including Digital Imaging and Communication in Medicine (DICOM) and the like.

Although a single medical apparatus 1, a single server 2, and a single other apparatus 3 are connected to the communication network N in the information system S shown in FIG. 1, this is merely an example. Single or multiple (any number of) medical apparatuses 1, servers 2, or other apparatuses 3 may be connected to the communication network N.

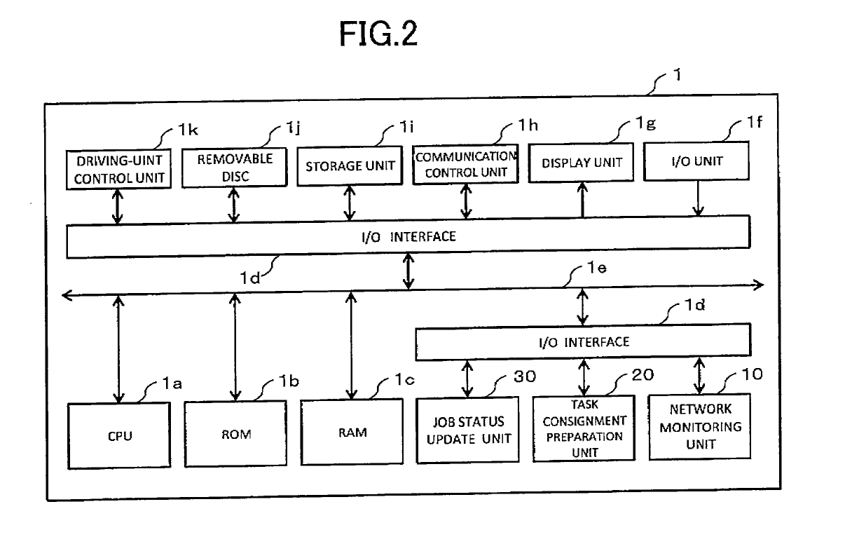

FIG. 2 is a block diagram showing the internal configuration of the medical apparatus 1 in the embodiment.

In the medical apparatus 1, a CPU (Central Processing Unit) 1a being a controller, a ROM (Read Only Memory) 1b, a RAM (Random Access Memory) 1c, and an I/O interface 1d are connected to one another via a bus 1e. The I/O interface 1d is connected to an input unit 1f, a display unit 1g, a communication control unit 1h, a storage unit 1i, a removable disc 1j, and a driving-unit control unit 1k.

Further, the I/O interface 1d is connected to a network monitoring unit 20, a task consignment preparation unit 20, and a job status update unit 30.

The CPU 1a executes a boot program for starting the medical apparatus 1 by reading the program from the ROM 1b on the basis of an input signal from the input unit 1f, and reads various operating systems stored in the storage unit 1i. The CPU 1a also controls various devices on the basis of input signals from other external equipment which are not shown in FIG. 2.

Further, the CPU 1a reads programs and data stored in the RAM 1c, the storage unit 1i, and the like and loads them onto the RAM 1c, and also functions as a processing device which implements a series of processing based on commands from the programs read from the RAM 1c, such as management of transmission of the medical information to other equipment connected to the communication network N and a task performed by the medical apparatus 1, processing for generation of an image, generation of information necessary in requesting the other apparatus to take over the task performed by the medical apparatus 1, data calculation, data processing, and the like.

The input unit 1f is configured with an input device, such as a keyboard or a dial, with which the user (e.g., a doctor or a technologist) of the medical apparatus 1 inputs various operations. The input unit 1f generates an input signal based on the operation made by the user, and sends the input signal to the CPU 1a via the bus 1e.

The display unit 1g is, for example, a liquid crystal display. The display unit 1g receives an output signal from the CPU 1a via the bus 1e, and displays, for example, a setting screen for conditions needed in the generation of the information necessary in requesting the other apparatus 3 to take over a task.

The communication control unit 1h is means, such as a LAN card or a modem, capable of connecting the medical apparatus 1 to the communication network N such as the Internet or a LAN. Data exchanged through the communication network N via the communication control unit 1h are sent to and received from the CPU 1a via the I/O interface 1d and the bus 1e, as an input signal or an output signal.

The storage unit 1i is configured of a semiconductor or a magnetic disc, and stores programs executed by the CPU 1a and data.

The removable disc 1j is an optical disc or a flexible disc, and signals read or written by a disc drive are sent to and received from the CPU 1a via the I/O interface 1d and the bus 1e.

Note that the removable disc 1j also includes a storage medium, such as a USB memory, configured to be connected to the medical apparatus 1 and to play functions similar to those played by the above-described removable disc 1j or the like.

The driving-unit control unit 1k controls a driving unit (not shown in FIG. 1) which drives each part of the medical apparatus 1. The type of the driving unit differs depending on the medical apparatus 1.

The network monitoring unit 10 monitors whether the medical apparatus 1 is connected to the communication network N or not, i.e., whether the connection is active or not. If the medical apparatus 1 is disconnected from the communication network N due to some failure, the network monitoring unit 10 informs the medical apparatus 1 of this situation. The network monitoring unit 10 may of course notify a user of the medical apparatus 1 of this via the display unit 1g.

If the medical apparatus 1 is disconnected from the communication network N, the task consignment preparation unit 20 performs preparation for consigning a task to the other apparatus 3, the task being performed between the medical apparatus 1 and the server 2 via the communication network N until the disconnection. The “preparation for consigning a task” mentioned herein includes preparing things that seem to be necessary for the other apparatus 3 to continue the task as the medical apparatus 1 in place of the medical apparatus 1, such as providing the other apparatus 3 with all the necessary information on the task.

The job status update unit 30 acquires a result of the task of the medical apparatus 1 taken over by the other apparatus 3 and incorporates the result in the task performed by the medical apparatus 1 (its own apparatus). In addition, the job status update unit 30 updates the status of each task so that a next task can be carried out smoothly with the server 2.

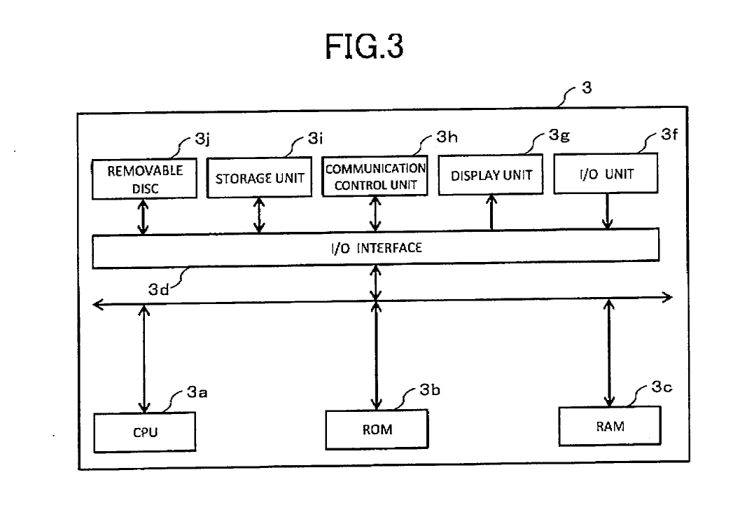

FIG. 3 is a block diagram showing the internal configuration of the other apparatus 3 in the embodiment.

In the other apparatus 3, a CPU (Central Processing Unit) 3a, a ROM (Read Only Memory) 3b, a RAM (Random Access Memory) 3c, and an I/O interface 3d are connected to one another via a bus 3e. The I/O interface 3d is connected to an input unit 3f, a display unit 3g, a communication control unit 3h, a storage unit 3i, and a removable disc 3j.

The other apparatus 3 is, as described earlier, a modality or an information terminal like the medical apparatus 1. Thus, the internal configuration of the other apparatus 3 is almost the same as that of the medical apparatus 1. For this reason, the other apparatus 3 is not described here for its individual internal configuration. Note that, if an information terminal for example is assumed as the other apparatus 3, the other apparatus 3 does not include, for example, a function corresponding to the driving-unit control unit 1k provided in the medical apparatus 1.

However, since the other apparatus 3 is to perform a task performed by the medical apparatus 1 (consigner) in place of the medical apparatus 1, the other apparatus 3 is required to be equipped with functions for taking over and continuing the task performed by the medical apparatus 1 (consigner) at least in the middle of the task. The other functions and configuration of the other apparatus 3 may be anything as long as the other apparatus 3 has such functions. Further, when the other apparatus 3 takes over a task of the medical apparatus 1, the other apparatus 3 is required to be connected (or maintain to be connected) with the server 2 via the communication network N.

When requesting the other apparatus 3 to take over a task in response to disconnection of the medical apparatus 1 from the communication network N, the task consignment preparation unit 20 of the medical apparatus 1 forms a consigned task execution unit in a medium (storage medium). A consigned task unit 40 is implemented in the other apparatus 3 when the storage medium is connected to the other apparatus 3 or when the other apparatus 3 reads the contents of the storage medium.

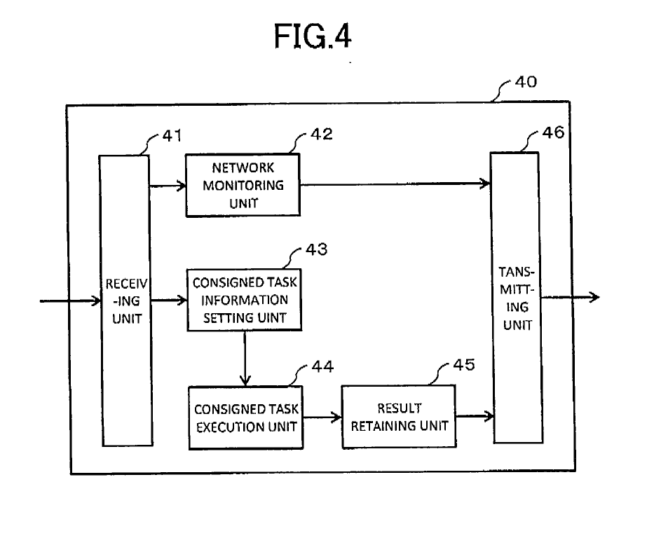

FIG. 4 is a block diagram showing the configuration of the consigned task unit 40 in the embodiment. The consigned task unit 40 includes a receiving unit 41, a network monitoring unit 42, a consigned task information setting unit 43, a consigned task execution unit 44, a result retaining unit 45, and a transmitting unit 46. The functions of these parts of the consigned task unit 40 are described below when appropriate along with a description of a flow of task consignment.

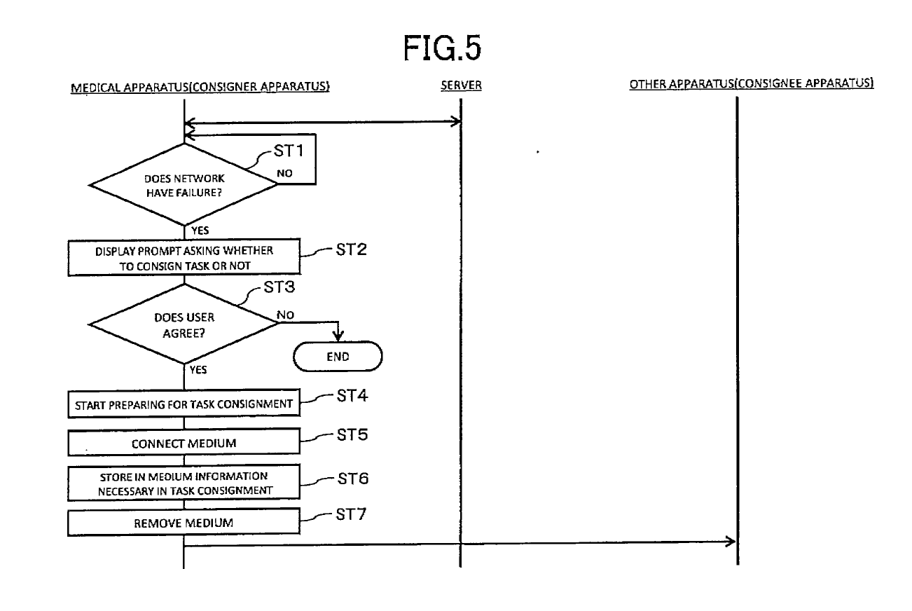

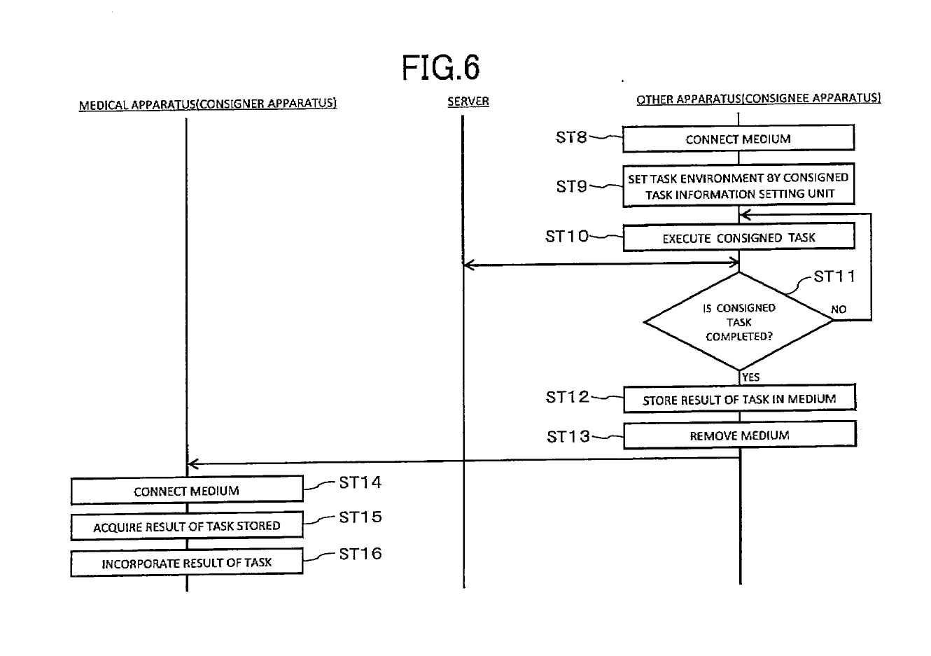

FIGS. 5 and 6 are sequence diagrams showing a flow of task consignment in the first embodiment. These sequence diagrams show a flow of information exchanged among the medical apparatus 1, the server 2, and the other apparatus 3. Thus, FIGS. 5 and 6 show what is performed by, from the left, the medical apparatus 1, the server 2, and the other apparatus 3 in chronological order.

The premise here is that the medical apparatus 1 is unable to continue a task performed with the server 2 due to disconnection from the communication network N and therefore consigns the task to the other apparatus 3. Thus, the medical apparatus 1 is a consigner apparatus, and the other apparatus 3 is a consignee apparatus. The server 2 is neither a consigner nor a consignee because the only thing different is whether the server 2 performs the task with the medical apparatus 1 or with the other apparatus 3, and what the server 2 performs concerning the task is not different in both cases.

First, with the medical apparatus 1 being connected to the communication network N, the medical apparatus 1 performs a task with the server 2. Examples of the “task” performed between the medical apparatus 1 and the server 2 include sending the server 2 a medical image indicating acquired (imaged) information on the interior of a subject (DICOM transfer), printing the medical image stored in the server 2 (DICOM print), informing the server 2 of an examination status in the medical apparatus 1 (Modality Performed Procedure Step (MPPS)), and the like.

Instructions and information concerning the task are exchanged between the medical apparatus 1 and the server 2 via the communication network N. Thus, both of the medical apparatus 1 and the server 2 have to be properly connected to the communication network N. In FIG. 5, a status in which both of them are connected to the communication network N and properly exchanging information and the like is shown with a double-headed arrow.

The network monitoring unit 10 of the medical apparatus 1 monitors as necessary whether or not the connection with the communication network N is canceled (disconnected) during the task due to network failure (ST1). This is because, if the medical apparatus 1 is disconnected from the communication network N, the task is interrupted, and the medical apparatus 1 has to request the other apparatus 3 to take over the task.

If the communication environment is favorable, causing no failure of the communication network N (NO in ST1), the task is continued between the medical apparatus 1 and the server 2 without the action of the network monitoring unit 10 becoming overt.

On the other hand, if communication failure is present in the communication network N and the network monitoring unit 10 recognizes that the medical apparatus 1 is disconnected (YES in ST1), a prompt asking the user whether or not to consign the task is displayed on the display unit 1g (ST2). The task performed between the medical apparatus 1 and the server 2 cannot be continued when the medical apparatus 1 is disconnected from the communication network N. Thus, the user is asked how to handle the task interrupted due to the disconnection from the communication network N via which the medical apparatus 1 performs the task with the server 2.

Here, occurrence of failure of the communication network N is displayed on the display 1g to ask the user whether or not to consign the task. However, the user may be asked about that by any other methods, e.g., by voice or the like, as far as the capability of the medical apparatus 1 permits.

When informed, the user determines whether or not to consign the task and gives an affirmative or negative response. In other words, the user shows whether he or she agrees to consignment of the task or not (ST3). If the user does not agree to task consignment (and a disagreement signal is inputted) (NO in ST3), the medical apparatus 1 ends the task since it is being disconnected from the communication network N. After this, various tasks may be performed, such as bringing together the contents of the task performed up until the disconnection from the communication network N or checking progress of the task.

If the user agrees to the task consignment (YES in ST3), the task consignment preparation unit 20 starts necessary preparation for consigning the task to the other apparatus 3 in the middle of the task (ST4). Specifically, the preparation for the task consignment is to store, in a storage medium, information necessary for the other apparatus 3 (consignee) to perform the task. To do this, the storage medium is for example connected to the medical apparatus 1 (ST5), and the medical apparatus 1 outputs necessary information to the storage medium and stores the information in the storage medium (ST6). Examples of the storage medium used to store the information therein include, for example, a USB or a DVD. It does not matter whether or not the storage medium is of a type which allows additional information to be recorded.

The following are possible as the information necessary for the other apparatus 3 to perform the task. As information on task consignment, the necessary information includes, for example, information on the task. This is information on the task to be consigned by the medical apparatus 1 to the other apparatus 3, i.e., information on the task performed between the medical apparatus 1 and the server 2 up until the medical apparatus 1 is disconnected from the communication network N.

For example, if the task performed by the medical apparatus 1 is the above-described “DICOM transfer,” examples of the information on the task include a “list of image data waiting to be transferred to the server 2,” “image data waiting to be transferred,” and the like.

Other information, e.g., information on the consignee other apparatus 3 is also stored as the necessary information. Any apparatus can be selected as the other apparatus 3, i.e., the consignee, as long as the apparatus is connected to the communication network N. Thus, for example, the necessary information also includes other information, such as “AE Title” and “Host Name,” which are needed to show which apparatus is to be the consignee of the task every time task consignment is requested. These pieces of information are necessary in order for the other apparatus 3 to perform the task as the medical apparatus 1 and not to make the server 2 conscious of change in its communication counterpart.

Further, software which is used by the other apparatus 3 in executing the task consigned by the medical apparatus 1, or which makes the execution of the task possible is also stored in the storage medium. An apparatus requested to a consignee of the interrupted task is requested when the medical apparatus 1 is disconnected from the communication network N due to occurrence of failure of the communication network N may basically be any apparatus as long as it is connected to the communication network N. However, the capabilities (specs) of the apparatuses connected to the communication network N are not the same in some cases, and apparatuses of various levels may possibly coexist. For this reason, software necessary to execute the task is stored in the storage medium which is passed to the other apparatus 3, so that every apparatus can take over and execute the task of the medical apparatus 1. Thereby, an apparatus capable of taking over the task do not have to be selected from the apparatuses connected to the communication network N for every task consignment, and every apparatus connected to the communication network N can be requested to take over and execute the task.

When the storage medium is connected to the other apparatus 3, the software stored in the storage medium in advance is activated, implementing the consigned task unit 40 shown in FIG. 4 in the other apparatus 3.

Note that the information stored in the storage medium is not limited to the information described above, and can be determined in consideration of functions and the like of the information system constructed in the institution or apparatuses constituting the information system and connected to the communication network N.

Once the task consignment preparation unit 20 of the medical apparatus 1 completes storing information in the storage medium, the storage medium is removed from the medical apparatus 1 (ST7) and passed to the other apparatus 3.

The storage medium is connected to an apparatus to which the task is to be consigned (the other apparatus 3) and which has received the storage medium (ST8 in FIG. 6). Connection of the storage medium to the other apparatus 3, as described above, implements the consigned task unit 40 in the other apparatus 3.

In the consigned task unit 40 thus implemented, first, the consigned task information setting unit 43 performs setting of a task environment (ST9) so that the other apparatus 3 can execute the task of the medical apparatus 1 disconnected from the communication network N. The setting of a task environment here is to reproduce, on the other apparatus 3, the execution situation of the task performed by the medical apparatus 1. By setting such a task environment, the other apparatus 3 taking over the task performed by the medical apparatus 1 can continue the task as the medical apparatus 1 instead of taking over and continuing the task in the name of the other apparatus 3.

Note that the task environment set by the consigned task information setting unit 43 can of course be an environment which is set to meet the capability (spec) of the other apparatus 3, instead of the task environment of the medical apparatus 1 reproduced as described above.

With that, the task performed by the medical apparatus 1 can be taken over and executed by the other apparatus 3. Thus, the consigned task is actually performed by the other apparatus 3 (the consigned task execution unit 44) (ST10). To execute the task, the other apparatus 3 and the server 2 communicate with each other via the communication network N. Thus, the premise is that the communication network N between the other apparatus 3 and the server 2 has no failure and allows them to properly exchange information. In FIG. 6, a double-headed arrow indicates that they are exchanging instructions and the like under a favorable communication environment.

The consigned task execution unit 44 executes the task consigned by the medical apparatus 1, and also checks whether the task is completed or not as needed (ST11). If the consigned task is not completed, the consigned task execution unit 44 continues the consigned task (NO in ST11).

On the other hand, if the consigned task execution unit 44 confirms that the entire consigned task is completed (YES in ST11), a result of the task is stored and retained in the result retaining unit 45 (ST12). Since the result retaining unit 45 is provided within the storage medium, the result of the task is stored and retained in the storage medium.

Then, the storage medium is removed from the other apparatus 3 (ST13), and is passed and connected to the medical apparatus 1 (ST14). Note that, at this stage, the medical apparatus 1 does not have to have a favorable communication environment, i.e., does not have to be connected to the communication network N.

In the medical apparatus 1, the job status update unit 30 acquires the result of the task consigned to and executed by the other apparatus 3 from the result retaining unit 45 in the storage medium (ST15). Then, the job status update unit 30 incorporates the result of the task in the contents of the task performed by the medical apparatus 1 until the disconnection from the communication network N due to failure (ST16). In incorporating the result in the contents of the task, the job status update unit 30 appropriately updates the status of the task for each of its contents.

Further, in this event, the job status update unit 30 compares the result of the task performed by the medical apparatus 1 until the occurrence of failure of the communication network N, the result being stored in the storage unit 1i of the medical apparatus 1, with the acquired result of the task performed by the other apparatus 3. As a result of the comparison between the former and the latter, a redundant task result is eliminated from either the former or the latter so that there may be no redundancy in the task.

By the above processing, a task originally started by the medical apparatus 1 but interrupted halfway is taken over and executed by the other apparatus 3 and is completed. Further, the other apparatus 3 to which the task is consigned executes the task not as a task of the other apparatus 3 but as a task of the medical apparatus 1. Thus, the task is considered to have been executed by the medical apparatus 1.

As described above, what can be provided are a medical apparatus, an information system, and a data recovery method in which, even when a medical apparatus becomes unavailable due to failure of a communication network in medical scenes, a task performed by the medical apparatus can be consigned to any apparatus connected to the communication network so that the apparatus can continue the task of the medical apparatus.

Further, since sufficient preparation is done such as storing of information necessary for the medical apparatus to request task consignment to the other apparatus, the consignee other apparatus can continue the task adequately. Further, such preparation eliminates the need for selecting a backup apparatus and therefore the need for previously preparing a backup apparatus dedicated for taking over tasks. Hence, this avoids an inconvenience in which the prepared backup apparatus cannot be used as a backup device because of being affected by failure in a communication network, and makes sure that the other apparatus can continue the task.

### Second Embodiment

Next, a second embodiment of the present invention will be described. In the second embodiment, the same constituents as the constituents described above in the first embodiment will be designated by the same reference numerals and duplicate explanation of the same constituents will be omitted herein.

The second embodiment is different from the first embodiment in that a result of a consigned task executed by the other apparatus 3 is transmitted to the medical apparatus 1 via the communication network N, instead of being passed to the medical apparatus 1 via a storage medium.

Specifically, the second embodiment is the same as the first embodiment up until consignment of a task performed by the medical apparatus 1 is prepared due to occurrence of failure of the communication network N in the middle of the task, and the task is consigned to the other apparatus 3.

In the second embodiment, since the result of the task performed by the other apparatus 3 is sent to the medical apparatus 1 via the communication network N, the premise is that, at the time when the task result is sent from the other apparatus 3, the communication network is recovered from the failure and that the medical apparatus 1 is normally connected to the communication network N.

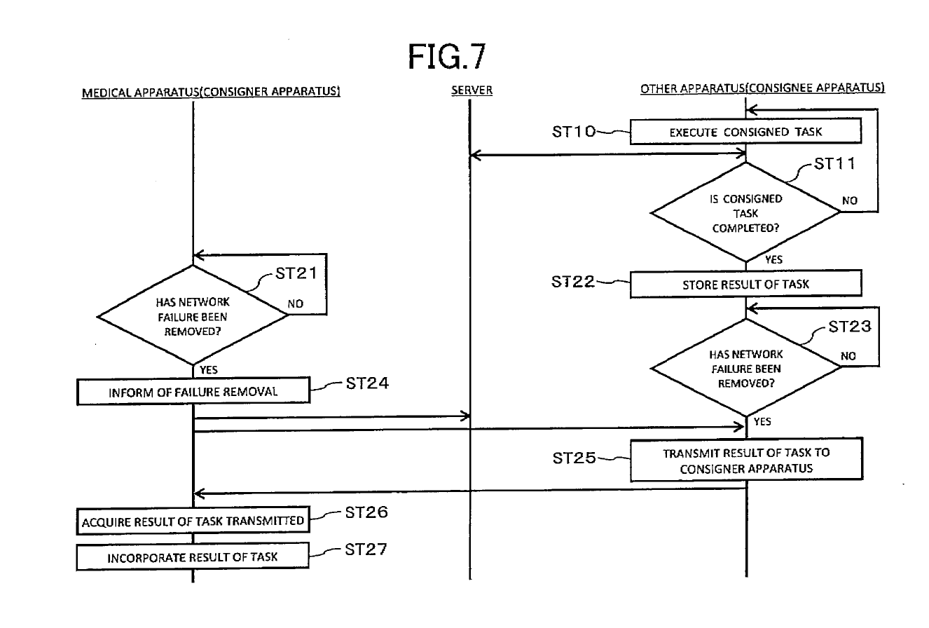

FIG. 7 is a sequence diagram showing a flow of task consignment in the second embodiment. After consigning a task performed by the medical apparatus 1 to the other apparatus 3, the network monitoring unit 10 of the medical apparatus 1 checks, as needed, whether the communication network N is recovered from the failure or not (ST21).

Meanwhile, when the other apparatus 3 completes the entire consigned task (YES in ST11), a result of the task is stored and retained (ST22). The task result may be stored and retained in, but not limited to, a storage medium, or may be stored and retained in the storage unit 3i of the other apparatus 3. This is because, since the task result is finally sent to the medical apparatus 1 via the communication network N, the task result does not have to be stored and retained in the storage medium when transmitted.

Further, the other apparatus 3, too, checks whether the communication network N is recovered from the failure or not. Specifically, the network monitoring unit 42 in the consigned task unit 40 of the other apparatus 3 checks whether the communication network N has failure or not (ST23). The network monitoring unit 42 of the other apparatus 3 of course monitors whether its own apparatus (the other apparatus 3) is connected to the communication network N or not. In addition, the communication network N monitored by the network monitoring unit 42 may be the entire communication network N, or may be limited to whether the consigner medical apparatus 1 which has consigned the task is connected to the communication network N or not.

If the network monitoring unit 10 of the medical apparatus 1 confirms that the communication network N is recovered from the failure and that the medical apparatus 1 is connected to the communication network N again (YES in ST21), the network monitoring unit 10 informs each apparatus connected to the communication network N of the fact that the communication failure has been removed (ST24). In the sequence diagram shown in FIG. 7, the medical apparatus 1 informs the server 2 and the other apparatus 3 requested by the medical apparatus 1 to be a consignee of the task, that the communication network N is recovered from the failure and restored.

Upon receipt of the information on the restoration of the communication network N from the medical apparatus 1, the other apparatus 3 confirms that the communication network N is recovered from the failure. Then, the other apparatus 3 sends the task result to the medical apparatus 1, which is the consigner apparatus, via the communication network N (ST25).

In the medical apparatus 1, the job status update unit 30 acquires the task result from the other apparatus 3 to which the medical apparatus 1 has consigned the task (ST26), and incorporates the task result in the contents of the task performed by the medical apparatus 1 itself until the disconnection of the medical apparatus 1 from the communication network N due to the failure (ST27). By this processing, a task originally started by the medical apparatus 1 but interrupted halfway is taken over and executed by the other apparatus 3 and is completed.

As described earlier in the first embodiment, the job status update unit 30 incorporates the result of a task taken over and performed by the other apparatus 3 in the result of the task originally performed by the medical apparatus 1 after comparing the former with the latter and eliminating redundancy in them, and updates the status of the task.

As described above, what can be provided are a medical apparatus, an information system, and a data recovery method in which, even when a medical apparatus becomes unavailable due to failure of a communication network in medical scenes, a task performed by the medical apparatus can be consigned to any apparatus connected to the communication network so that the apparatus can continue the task of the medical apparatus.

Further, since sufficient preparation is done such as storing of information necessary for the medical apparatus to request task consignment to the other apparatus, the consignee other apparatus can continue the task adequately. Further, such preparation eliminates the need for selecting a backup apparatus and therefore the need for previously preparing a backup apparatus dedicated for taking over tasks. Hence, this avoids an inconvenience in which the prepared backup apparatus cannot be used as a backup device because of being affected by failure in a communication network, and makes sure that the other apparatus can continue the task.

Furthermore, since the other apparatus 3 which has performed the consigned task sends the task result to the medical apparatus 1 via the restored communication network N, contents of the consigned task can be incorporated easily and surely in the medical apparatus 1 which has originally performed the task.

In the above-described embodiments of the invention of the present application, the premises is that the network monitoring unit 10 monitors whether or not failure occurs in the communication network N. Instead of the above case, an operator may recognize occurrence of failure of the communication network N and initiate task consignment, or even if no failure occurs in the communication network N, a task may be consigned to another apparatus at the discretion of the operator, by following the processing flow described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical apparatus comprising:
a storage unit configured to store medical information;
a communication controller configured to communicate, via a communication network, the medical information with other equipment connected to the communication network;
a controller configured to manage transmission of the medical information to the other equipment and a task performed by the medical apparatus; and
a task consignment preparation unit configured to prepare a storage medium storing information necessary for the medical apparatus to consign a task performed by the medical apparatus to another apparatus connected to the communication network.

2. The medical apparatus according to claim 1, further comprising a network monitoring unit configured to monitor whether connection of the medical apparatus to the communication network is active or not.

3. The medical apparatus according to claim 1, wherein
the information stored in the storage medium by the task consignment preparation unit is software which enables the other apparatus to perform the consigned task.

4. The medical apparatus according to claim 1, wherein
the information stored in the storage medium by the task consignment preparation unit includes a medical image related to the consigned task.

5. The medical apparatus according to claim 1, wherein
the information stored in the storage medium by the task consignment preparation unit is information on the consigned task, information on the other apparatus, and software which enables the other apparatus to perform the consigned task.

6. The medical apparatus according to claim 1, further comprising a job status update unit configured to receive a result of the consigned task.

7. The medical apparatus according to claim 3, wherein
the consigned task is processing related to transfer of the medical image.

8. The medical apparatus according to claim 3, wherein
the consigned task is at least one of processing related to printing of the medical image and Modality Performed Procedure Step.

9. The medical apparatus according to claim 6, wherein
upon receipt of the result of the consigned task from the other apparatus, the job status update unit eliminates a redundant task result by comparing the task performed by the medical apparatus with the received result.

10. An information system comprising:
a medical apparatus including a storage unit configured to store medical information, a communication controller configured to communicate, via a communication network, the medical information with other equipment connected to the communication network, a controller configured to manage transmission of the medical information to the other equipment and a task performed by the medical apparatus, and a task consignment preparation unit configured to prepare a storage medium storing information necessary for the medical apparatus to consign a task performed by the medical apparatus to another apparatus connected to the communication network;
a server which is a counterpart of the medical apparatus for the task; and
another apparatus which is any apparatus connected to the communication network and which accepts consignment of the task from the medical apparatus and continues the consigned task with the server.

11. The information system according to claim 10, wherein
the medical apparatus further includes a network monitoring unit configured to monitor whether connection of the medical apparatus to the communication network is active or not.

12. The information system according to claim 10, wherein
the information stored in the storage medium by the task consignment preparation unit of the medical apparatus is software which enables the other apparatus to perform the consigned task.

13. The information system according to claim 10, wherein
the information stored in the storage medium by the task consignment preparation unit of the medical apparatus includes a medical image related to the consigned task.

14. The information system according to claim 10, wherein
the information stored in the storage medium by the task consignment preparation unit of the medical apparatus is information on the consigned task, information on the other apparatus, and software which enables the other apparatus to perform the consigned task.

15. The information system according to claim 10, wherein
the medical apparatus further includes a job status update unit configured to receive a result of the consigned task.

16. The information system according to claim 12, wherein
the task consigned by the medical apparatus is processing related to transfer of the medical image.

17. The information system according to claim 12, wherein
the task consigned by the medical apparatus is at least one of processing related to printing of the medical image and Modality Performed Procedure Step.

18. The information system according to claim 15, wherein
upon receipt of the result of the consigned task from the other apparatus, the job status update unit of the medical apparatus eliminates a redundant task result by comparing the task performed by the medical apparatus with the received result.

19. A data recovery method comprising:
storing, in a storage medium, information necessary in consigning a task performed by a medical apparatus to any other apparatus connected to a communication network;
passing the storage medium to the other apparatus and causing the other apparatus to take over the task consigned thereto;
storing, by the other apparatus, a result of the task in the storage medium;
passing the storage medium storing the result of the task to the medical apparatus and thereby acquiring, by the medical apparatus, the result of the task; and
incorporating the result of the task in a result of the task in the medical apparatus.

20. The data recovery method according to claim 19, comprising, before the step of storing, in the storage medium, the information necessary for the medical apparatus to consign the task to the other apparatus, a step of checking, by a network monitoring unit, whether or not the communication network is disconnected during the task performed between the medical apparatus and a server to which the medical apparatus is connected via the communication network.

21. A data recovery method comprising:
storing, in a storage medium, information necessary in consigning a task performed by a medical apparatus to any other apparatus connected to a communication network;
passing the storage medium to the other apparatus and causing the other apparatus to take over the task consigned thereto;
storing, by the other apparatus, a result of the task in the storage medium;
sending the result of the task from the other apparatus to the medical apparatus via the communication network;
receiving and acquiring, by the medical apparatus, the result of the task; and
incorporating the result of the task in a result of the task in the medical apparatus.

22. The data recovery method according to claim 21, comprising, before the step of storing, in the storage medium, the information necessary for the medical apparatus to consign the task to the other apparatus, a step of checking, by a network monitoring unit, whether or not the communication network is disconnected during the task performed between the medical apparatus and a server to which the medical apparatus is connected via the communication network.

23. The data recovery method according to claim 22, comprising, after the step of causing the other apparatus to store the result of the task in the storage medium, checking, by the other apparatus, whether or not the connection between the medical apparatus and the communication network is restored.
